(19) United States
(12) Patent Application Publication
(10) Pub. No.: US 2015/0186758 A1
(43) Pub. Date: Jul. 2, 2015

(54) IMAGE PROCESSING DEVICE

(71) Applicant: Konica Minolta Laboratory U.S.A., Inc., San Mateo, CA (US)

(72) Inventor: Jun Kuroki, Superior, CO (US)

(73) Assignee: Konica Minolta Laboratory U.S.A., Inc., San Mateo, CA (US)

(21) Appl. No.: 14/145,507

(22) Filed: Dec. 31, 2013

(51) Int. Cl. G06K 15/02

(52) U.S. Cl. CPC G06K 15/1802

(57) ABSTRACT

A method for printing, including: receiving, by a printer, an electronic document (ED) including a requested font; determining, by the printer, that the requested font is not supported by the printer; identifying, by the printer, a substitute font for the requested font; and generating, by the printer and by using the substitute font as a replacement for the requested font in the ED, a hardcopy corresponding to the ED and including a name of the requested font and a name of the substitute font.

### BACKGROUND

Millions of electronic documents (EDs) are generated every day. These EDs may use any number of a nearly limitless supply of fonts. When a printer receives an ED for printing, it is possible that one or more of the fonts requested in the ED are not supported by the printer. As a result, the hardcopy of the ED may have substituted fonts used. Moreover, it may be difficult to establish from looking at the hardcopy of the ED, the name(s) of the substituted fonts, and which font they were substituted for.

### SUMMARY OF INVENTION

In general, in one aspect, the invention relates to a method for printing. The method comprises: receiving, by a printer, an electronic document (ED) comprising a requested font; determining, by the printer, that the requested font is not supported by the printer; identifying, by the printer, a substitute font for the requested font; and generating, by the printer and by using the substitute font as a replacement for the requested font in the ED, a hardcopy corresponding to the ED and comprising a name of the requested font and a name of the substitute font.

In general, in one aspect, the invention relates to a non-transitory computer-readable medium (CRM) storing a plurality of instructions for printing. The plurality of instructions comprise functionality for: receiving, using a printer, an electronic document (ED) comprising a requested font; determining, using the printer, that the requested font is not supported by the printer; identifying, using the printer, a substitute font for the requested font; and generating, using the substitute font as a replacement for the requested font in the ED, a hardcopy corresponding to the ED and comprising a name of the requested font and a name of the substitute font.

In general, in one aspect, the invention relates to a system for printing documents. The system comprises: a printer comprising functionality to: receive an electronic document (ED) comprising a requested font; determine that the requested font is not supported by the printer; identify a substitute font for the requested font; and generate, using the substitute font as a replacement for the requested font in the ED, a hardcopy corresponding to the ED and comprising a name of the requested font and a name of the substitute font.

Other aspects and advantages of the invention will be apparent from the following description and the appended claims.

### BRIEF DESCRIPTION OF DRAWINGS

FIG. 1 shows a schematic diagram in accordance with one or more embodiments of the invention.

FIG. 2 shows a flowchart of a method in accordance with one or more embodiments of the invention.

FIG. 3 shows an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for printing. Specifically, an ED is received by a printer. The ED may be received as part of a direct print request. The ED includes at least one requested font. A determination is made whether the requested font is support by the printer. When the requested font is not supported by the printer, a substitute font is identified by the printer. Subsequently, the printer generates a hardcopy of the ED using the substitute font as a replacement for the requested font. The hardcopy also includes the name of the requested font and the name of the substitute font. The name of the requested font and the substitute font may be located on a physical font substitution information (PFSI) page of the hardcopy.

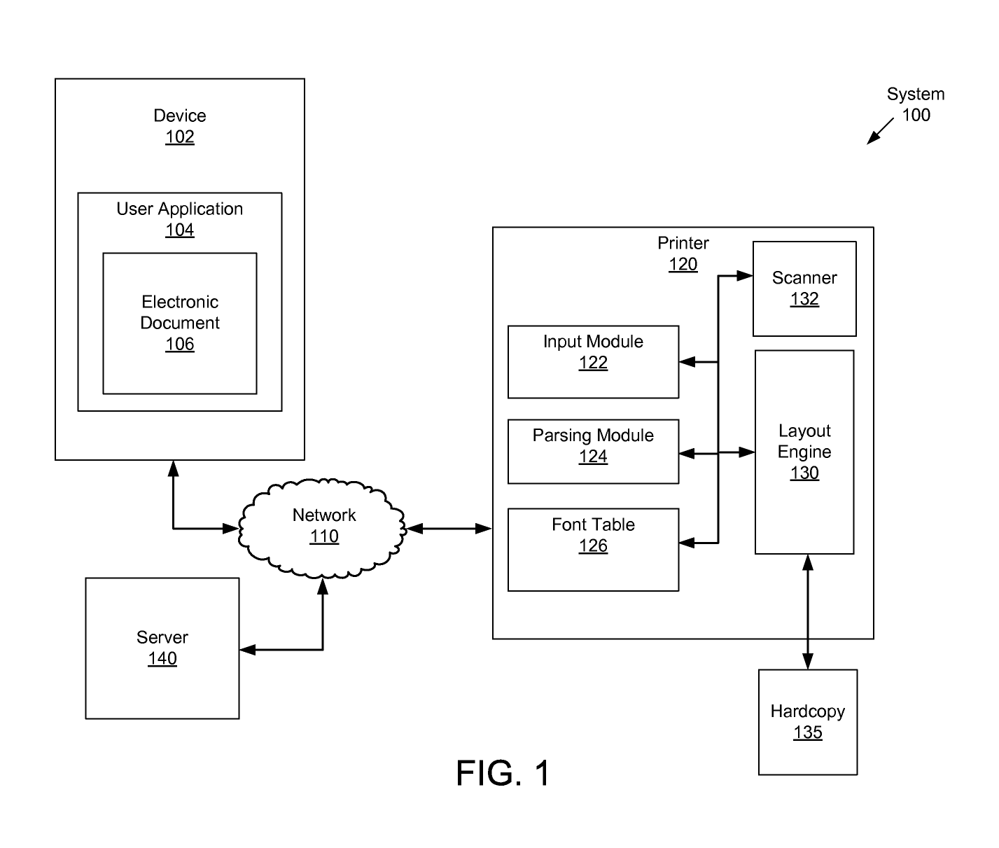

FIG. 1 shows a system (100) in accordance with one or more embodiments of the invention. As shown in FIG. 1, the system (100) has multiple components including device (102), server (140), and printer (120) connected via a network (110) with wired and/or wireless segments. The device (102) may correspond to a server, a mainframe, a desktop Personal Computer (PC), a laptop, a Personal Digital Assistant (PDA), a telephone, a tablet computer, a smart phone, a kiosk, a cable box, and/or any other hardware device.

In one or more embodiments of the invention, the device (102) executes the user application (104). The user application (104) is a software application operated by a user and configured to obtain, input, generate, display, and/or print an ED (e.g., Electronic Document (106)) having any number of pages. Accordingly, the user application (104) may be a word processor, slide presentation software, spreadsheet software, graphics software, Internet browser, desktop publishing software, video editor, and so forth. The ED (106) may be a report or form.

In one or more embodiments of the invention, the ED (106) includes one or more requested fonts. In other words, the requested fonts are fonts that are specified in the ED (106) for use in printing/displaying one or more text segments. The requested fonts in the ED (106) may be default fonts included in user application (104), may be fonts created by the user, may be fonts downloaded from the Internet, or may fonts that come from any other source. In one or more embodiments of the invention, the ED (106) is represented/defined using a document markup language (e.g., Open Document Format (ODF), Open Office XML (OOXML), etc.). Accordingly, the requested fonts in the ED (106) may be recorded as attributes within the tags of the document markup language.

In one or more embodiments of the invention, the printer (120) is a Multi-Function Printer (MFP). A MFP is a printer that includes other functionality such as scanning or faxing, Internet access, and typically has a user interface, such as a touch screen, allowing complex interactions to be performed at the MFP itself, rather than having to use another device, such as a computer. As shown in FIG. 1, the printer (120) may include a scanner (132). Moreover, the printer (120) may have network (e.g., Internet) access to the server (140). It will be clear to one of ordinary skill in the art that the MFP many have additional functionalities and, as such, the invention should not be limited to the above examples.

In one or more embodiments of the invention, the printer (120) includes an input module (122). The input module (122) may be configured to receive the ED (106) from device (102) and store the ED (106) in a queue (not shown). Specifically, the input module (122) may receive the ED as part of a direct print request from the device (102) to print the ED (106). The input module (122) may prioritize the ED (106) with respect to the other EDs (not shown) already stored in the queue.

In one or more embodiments of the invention, the printer (120) includes a font table (126). The font table (126) stores the identities of all fonts supported by the printer. One or more of these fonts might have been installed by the manufacturer of the printer (120). One or more of these fonts may have been installed by a user of the printer (120). The font table (126) also includes a set of mappings between unsupported fonts (i.e., fonts that are not supported by the printer) and supported fonts. The mappings identify a supported font that may be substituted for an unsupported requested font. For example, assume “Special Font Z” is an unsupported font. Further, assume “Times New Roman” is a font supported by the printer (120). Further still, assume that “Times New Roman” should be the substitute font for “Special Font Z.” Accordingly, the font table (126) would: (i) identify “Times New Roman” as a supported font; (ii) identify “Special Font Z” as an unsupported font; and (iii) would have a link mapping “Special Font Z” to “Times New Roman.” As discussed above, there are many different types of fonts available. Accordingly, it is possible that the font table (126) does not have the identity of every single unsupported font. In such embodiments, the font table (126) may include default mappings that link an unknown, and thus unsupported, font to a supported font. The initial mappings may be set by the manufacturer of the printer (120). One or more mappings may be altered by a user of the printer (120).

In one or more embodiments of the invention, the printer (120) includes a parsing module (124). The parsing module (124) may be configured to identify, by parsing the ED (106), one or more requested fonts specified in the ED (106). The parsing module (124) may also be configured to determine which of the requested fonts are supported by the printer (120) and which of the requested fonts are not supported by the printer (120). Specifically, the parsing module (124) may compare one or more of the requested fonts in the ED (106) with the font table (126). The comparison may be made for all requested fonts. If the requested font is not supported by the printer (120), the identity of the substitute font for the requested font is obtained from the font table (126). Moreover, the requested font in the ED is replaced with the substitute font. The font table (126) may be a list, a queue, a linked-list, a database, or any type of repository.

In one or more embodiments of the invention, the printer (120) includes a layout engine (130). The layout engine (130) is configured to generate the hardcopy (135) of the ED (106) (i.e., print the ED (106)). In one or more embodiments of the invention, the layout engine (130) may generate page images. In the case of EDs described/represented using a document markup language (e.g., OOXML), the layout engine (130) may calculate the page positions (i.e., coordinates) of all elements on the pages. In other words, the layout engine (130) may execute a layout of the ED (106) according to the formatting specified in the ED (106), including the requested fonts and, where necessary, substitute fonts, as supported by the printer (120).

In one or more embodiments of the invention, the hardcopy (135) includes a physical font substitution information (PFSI) page. The PFSI page includes the names of the one or more requested fonts in the ED (106) that are unsupported by the printer (120). Further, the PFSI page may include the name of the substitute font for each unsupported requested font. Further still, the PFSI page may also identify the location (e.g., by page number, line number, etc.) within the hardcopy (135) where the substitute font(s) is visible. Optionally, the PFSI page may identify all requested fonts specified in the ED (106), even the ones supported by the printer (120). The names of the requested fonts and the corresponding substitute fonts may be positioned within a table on the PFSI page. In one or more embodiments of the invention, the PFSI page is the final page in the hardcopy (135). In one or more embodiments of the invention, the PFSI page is the first page in the hardcopy (135).

In one or more embodiments of the invention, the PFSI page includes a symbol for each unsupported requested font. The symbol may correspond to a URL link, a 2D barcode, a data glyph, text, etc. The symbol effectively stores the name/identity of the unsupported requested font. The printer (120) may scan the symbol using the scanner (132), extract the name/identity of the requested font from the scanned symbol, and then upload, via network (110), the name/identity to a website storing multiple fonts. The website may be located on server (140). For example, the website may be the printer manufacturer's website and/or a third-party website that sells fonts. In response to accessing the website and uploading the name/identity of the font, the printer (120) may download the requested font (e.g., from server (140)) for installation. Accordingly, the requested font is now supported by the printer (120) and can be utilized during the printing of future EDs that specify the requested font. Additionally or alternatively, the ED may be re-printed using the newly supported/installed font.

Optionally, in one or more embodiments of the invention, any of the information presented on the PFSI page may be displayed on one or more screens of the printer (120), such as those used for navigating the various menus and commands of the printer (120).

Those skilled in the art, having the benefit of this detailed description, would appreciate that the PFSI page may be omitted. In such embodiments, the identity of a requested font and its substitute font may be positioned on any page within the hardcopy (135). For example, the identity of a requested font and its substitute font may be placed in header, footer, and/or margin of a page in the hardcopy (135) having one or more text segments specified in the ED (106).

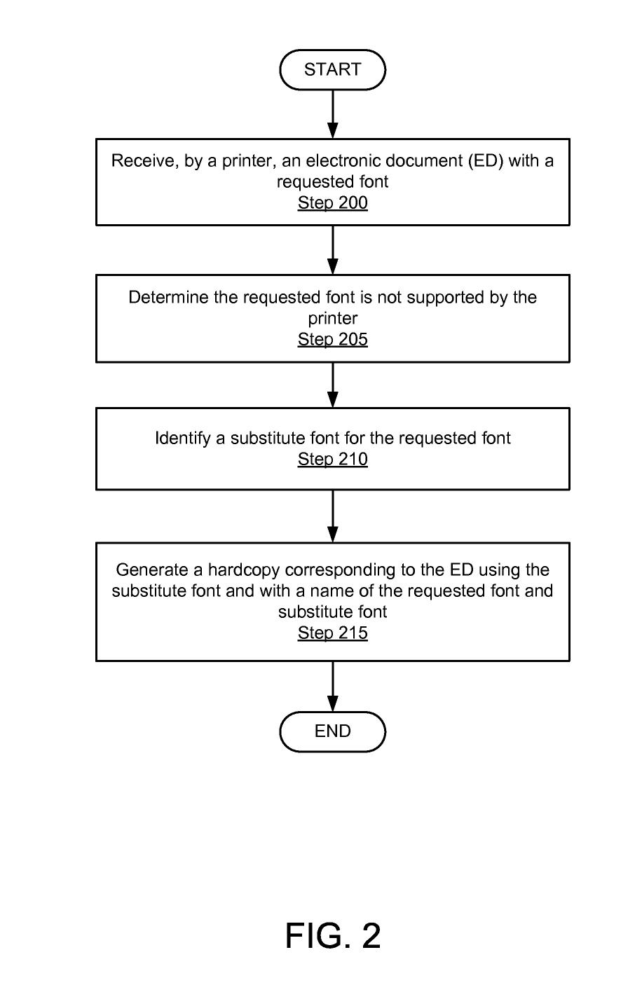

FIG. 2 shows a flowchart corresponding to a method for printing. While the various steps in this flowchart are presented and described sequentially, One of ordinary skill in the art will appreciate that some or all of the steps may be executed in different orders and some or all of the steps may be executed in parallel. Further, in one or more embodiments of the invention, one or more of the steps described below may be omitted, repeated, and/or performed in a different order. Accordingly, the specific arrangement of steps shown in FIG. 2 should not be construed as limiting the scope of the invention.

In Step 200, an ED with a requested font is received by a printer, in accordance with one or more embodiments of the invention. The ED may be received in any manner now known or later developed. In one or more embodiments of the invention, the ED may be received via a direct print, where no pre-processing of the ED is performed (i.e., the printer performs any necessary layout/processing and no printer driver is involved). The ED may be in OOXML format, ODF, or any other markup language format. Accordingly, the requested font may be specified as an attribute in one or more tags of the ED.

In Step 205, a determination is made that the requested font is not supported by the printer, in accordance with one or more embodiments of the invention. The determination may be made in any manner now known or later developed. In one or more embodiments of the invention, the determination may be made by comparing the requested font to a list of all fonts supported by the printer, or any other suitable method.

In Step 210, a substitute font is identified for the requested font, in accordance with one or more embodiments of the invention. The substitute font may be identified in any manner now known or later developed. The substitute font may be identified using, for example, from a font table specifying mappings between unsupported requested fonts to substitute fonts that are supported by the printer. The mappings may be installed by default with the printer, determined by the user, manufacturer or other party, or may be established in any other suitable manner now known or later developed.

In Step 215, a hardcopy of the ED is generated with the substitute font replacing the requested font. The hardcopy also includes the name of the requested font and the name of its substitute font, in accordance with one or more embodiments of the invention. The name of the requested font and substitute font may be printed on a separate PFSI page before the ED or after the ED. The PFSI page may include the name of all requested fonts, the names of any substitute fonts, and may additionally include a symbol (e.g., 2D barcode, data glyph, etc.) for each unsupported requested font. The symbol stores the name/identity of the unsupported requested font. The printer may extract the name/identity of the unsupported requested font from the scanned symbol, and upload the name/identity of the font to a website, via a network, storing many fonts (e.g., an on-line store selling fonts). The printer may also download the unsupported font. The names of the requested fonts and/or substitute fonts may be presented in any suitable manner such as a table or list. As an alternative to the symbol, the printer may perform optical character recognition (OCR) on the printed name of the unsupported requested font. The data obtained from the OCR may be uploaded to the website with the fonts. Optionally, the PFSI page may also indicate a location(s) (e.g., a page number, line number, etc.) within the hardcopy where the substitution occurred. After Step 215, the method ends.

The following section describes various examples of the invention. The examples are included to aid in the understanding of the invention and are not intended to limit the scope of the invention.

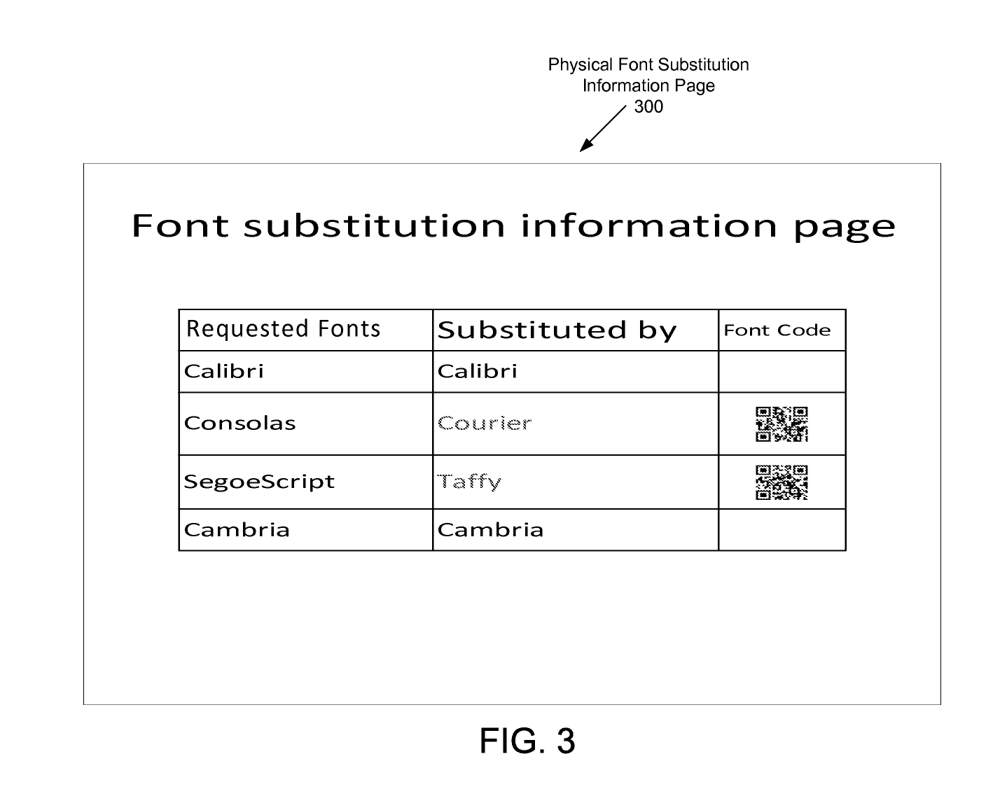

FIG. 3 shows a PFSI page (300) that may be created by a printer. Specifically, PFSI page (300) is an example of the information that may be printed in addition to an ED. PFSI page (300) may be printed before or after the hardcopy of the ED associated with PFSI page (300) is printed. In this example, the ED specified four requested fonts: Calibri, Consolas, SegoeScript, and Cambria. However, Consolas and SegoeScript are not supported by the printer that created PFSI page (300). Thus, PFSI page (300) lists in the table that Consolas was substituted with Courier, and SegoeScript was substituted with Taffy. Both Courier and Taffy are supported by the printer. In contrast, Calibri and Cambria, which are supported, are listed as being “substituted” by themselves.

Additionally, PFSI page (300) provides a “font code” for Consolas and SegoeScript. The font code in this example is a 2D barcode code that, when scanned by the printer, identifies the unsupported requested font. The printer may upload the identity of the unsupported requested font to a website storing fonts for download. Both Consolas and SegoeScript may be downloaded from the website, and subsequently installed to the printer, thereby enabling the printer to support Consolas and SegoeScript. Optionally, there may be a fee charged when downloading the font(s) using the 2D code provided in PFSI page (300). Thus, through PFSI page (300) a user is able to easily and rapidly identify which fonts are supported and unsupported by the printer, and take action accordingly (e.g., purchase the unsupported fonts, change the mappings in the font table link the unsupported font to a better substitute font, etc.).

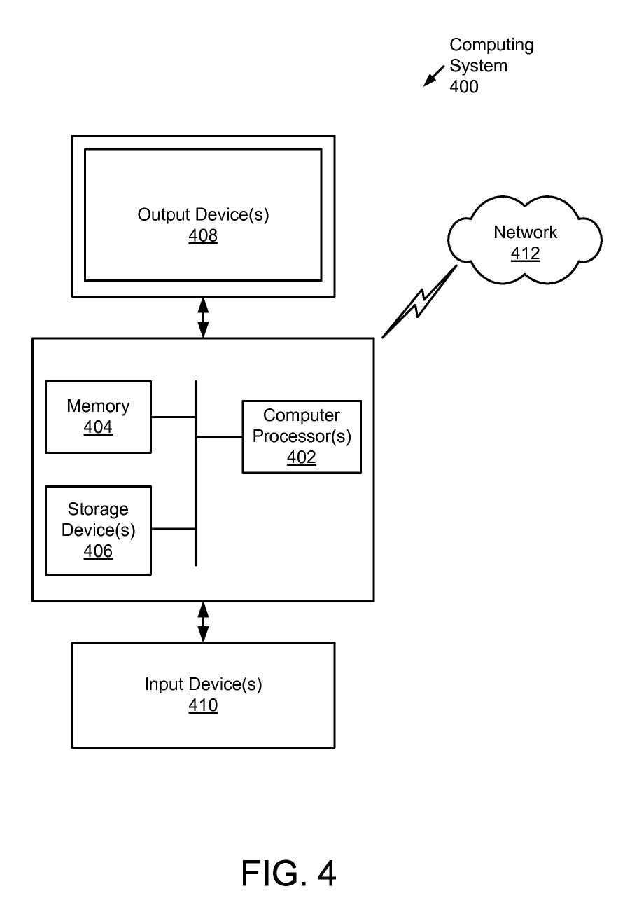

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for printing, comprising:
receiving, by a printer, an electronic document (ED) comprising a requested font;
determining, by the printer, that the requested font is not supported by the printer;
identifying, by the printer, a substitute font for the requested font; and
generating, by the printer and by using the substitute font as a replacement for the requested font in the ED, a hardcopy of the ED, the hardcopy comprising a name of the requested font and a name of the substitute font.

2. The method of claim 1, wherein generating the hardcopy comprises generating a physical font substitution information (PFSI) page comprising the name of the requested font and the name of the substitute font, wherein the ED does not include the PFSI page.

3. The method of claim 2, wherein the PFSI page further identifies a location in the hardcopy where the substitute font is present.

4. The method of claim 2, further comprising:
scanning, by the printer, a symbol on the PFSI page specifying the requested font;
accessing, by the printer, a network location; and
downloading, by the printer, the requested font from the network location.

5. The method of claim 4, wherein the symbol is at least one selected from a group consisting of a two-dimensional barcode and a data glyph.

6. The method of claim 1, wherein determining comprises:
comparing the requested font against a data structure of supported fonts.

7. The method of claim 1, wherein the printer is a Multi-Function Printer (MFP) comprising a processor and a memory.

8. The method of claim 1, wherein the ED is received via direct print.

9. A non-transitory computer-readable medium (CRM) storing a plurality of instructions for printing, the plurality of instructions comprising functionality for:
receiving, using a printer, an electronic document (ED) comprising a requested font;
determining, using the printer, that the requested font is not supported by the printer;
identifying, using the printer, a substitute font for the requested font; and
generating, using the substitute font as a replacement for the requested font in the ED, a hardcopy of corresponding to the ED, the hardcopy comprising a name of the requested font and a name of the substitute font.

10. The non-transitory CRM of claim 9, wherein generating the hardcopy comprises generating a physical font substitution information (PFSI) page comprising the name of the requested font and the name of the substitute font, wherein the ED does not include the PFSI page.

11. The non-transitory CRM of claim 10, wherein the PFSI page further identifies a location in the hardcopy where the substitute font is present.

12. The non-transitory CRM of claim 10, the plurality of instructions comprising further functionality for:
scanning a symbol on the PFSI page specifying the requested font;
accessing a network location; and
downloading the requested font from the network location.

13. The non-transitory CRM of claim 12, wherein the symbol is at least one selected from a group consisting of a two-dimensional barcode and a data glyph.

14. The non-transitory CRM of claim 9, wherein the instructions for determining comprise functionality for:
comparing the requested font against a data structure of supported fonts.

15. The non-transitory CRM of claim 9, wherein the printer is a Multi-Function Printer (MFP) comprising a processor and a memory.

16. The non-transitory CRM of claim 9, wherein the ED is received via direct print.

17. A system for printing documents, comprising:
a printer comprising functionality to:
receive an electronic document (ED) comprising a requested font;
determine that the requested font is not supported by the printer;
identify a substitute font for the requested font; and
generate, using the substitute font as a replacement for the requested font in the ED, a hardcopy of the ED, the hardcopy comprising a name of the requested font and a name of the substitute font.

18. The system of claim 17, wherein generating the hardcopy comprises generating a physical font substitution information (PFSI) page comprising the name of the requested font and the name of the substitute font, wherein the ED does not include the PFSI page.

19. The system of claim 17, wherein the PFSI page further identifies a location in the hardcopy where the substitute font is present.

20. The system of claim 17, the printer further comprising functionality to:
scan a symbol on the PFSI page specifying the requested font;
access a network location; and
download the requested font from the network location.
